(19) United States
(12) Patent Application Publication
(10) Pub. No.: US 2010/0146829 A1
(43) Pub. Date: Jun. 17, 2010

(54) Card Toy

(76) Inventor: Nana Haneda, Tokyo (JP)

Correspondence Address: STAAS & HALSEY LLP, SUITE 700, 1201 NEW YORK AVENUE, N.W., WASHINGTON, DC, 20005, US

(21) Appl. No.: 12/087,881

(22) PCT Filed: Jan. 18, 2007
(86) PCT No.: PCT/JP2007/050653

§ 371 Date: Jul. 16, 2008

(30) Foreign Application Priority Data
Jan. 20, 2006 (JP) 2006-000342

(51) Int. Cl. G09F 1/00; A63F 1/02

(52) U.S. Cl. 40/124.191

(57) ABSTRACT

A card toy is provided in which not only does play not end just when a picture is composed by superimposing pictures drawn on sheets but also additional elements including an element that can be used for a game and a transmission element such as a message are provided. In a card toy used for playing therewith by superimposing a plurality of cards made of a transparent material on a card made of a transparent or opaque material, the cards have respective pictures and marks of a predetermined shape indicated thereon. When the cards are superimposed, the pictures of the cards located at upper positions conceal at least part of the pictures of the cards located at the lower positions, so that the pictures of the cards located at the upper positions are combined with the pictures of the cards located at the lower positions. Further, the marks are arranged such that at least one of the marks may be matched with the marks of the other cards depending on a combination of the cards.

### TECHNICAL FIELD

The present invention relates to a card toy, and more specifically to a card toy in which a composite picture or design is formed by superimposing cards made of transparent sheets that have respective pictures indicated thereon while parts of the pictures on the cards located at lower positions are concealed by the picture or pictures on the card or cards located at upper positions and which can be applied to a game in which marks formed on the cards in addition to the pictures are either covered or not.

### BACKGROUND ART

Conventionally, a card toy has been proposed that comprises first cards on each of which a basic picture is depicted and second cards on each of which a picture for decoration that decorates the basic picture is depicted. When the second card is superimposed on the first card, the basic picture is decorated with the picture for decoration so that a predetermined picture or design is formed (refer to, for example, Patent document 1).

Patent document 1: Japanese Patent Application Laid-Open Publication No. 2003-33584

### DISCLOSURE OF THE INVENTION

### Problem to be Solved by the Invention

In the conventional card toy described above, part of the basic picture is concealed by the picture for decoration by overlapping the picture for decoration on the basic picture, to thereby display a composite picture or design. However, the play with this conventional card toy ends just when the design is simply composed with the basic picture being decorated.

The present invention has been made to solve the problem. Accordingly, an object of the present invention is to provide a card toy in which not only does play with the card toy not end just when a composite picture or design is composed by superimposing pictures depicted on sheets but also additional elements, such as an element that can be used for a game and an information transfer element such as a message or the like, are provided.

### MEANS FOR SOLVING PROBLEM

In order to solve the problem, a card toy used for playing by superimposing a plurality of cards made of a transparent material on a card made of a transparent or opaque material is provided according to the present invention, wherein the card toy is characterized in that: the card toy comprises cards that have respective pictures indicated thereon, wherein the pictures are so arranged that when one of the cards is superimposed on another card, the picture of the card located at an upper position conceals at least part of the picture of the card located at a lower position and is combined with the picture of the card located at the lower position; the cards include a plurality of groups each of which consists of a plurality of cards, wherein when cards of which one is selected from each group are superimposed on one another, a predetermined design is made; and the cards have a plurality of marks of a predetermined shape indicated thereon in addition to the picture, respectively, in such a manner that at least one of the marks of one card may be covered by a corresponding one of the marks on the other cards depending on a combination of the selected cards.

The card toy may be so constructed that one of the groups consists of basic cards on which the pictures are respectively depicted as a basic picture of a character or the like, and the cards of the other groups that are superimposed on the basic card have decorative pictures of clothes, accessories and the like depicted thereon so as to decorate the basic picture.

Further, the cards may be so constructed that the cards have respective words and/or phrases indicated thereon in letters in addition to the pictures and the marks, and when the selected cards are superimposed, the word and/or phrase of each card is/are connected to the words and/or phrases of other cards, to thereby make up one sentence.

### EFFECT OF THE INVENTION

According to the present invention, a composite picture to be completed varies depending on which cards are selected from each of the groups, and therefore the pleasure that the pictures are simply superimposed and which pictures are combined with which pictures can be enhanced, and moreover, the card toy can be realized in which not only are the pictures drawn on the cards combined but also both the pleasure of simply combining the pictures drawn on the cards and the development of a game with the use of the cards are possible because the number of the marks changes depending on overlapping condition of the marks.

According to one embodiment of the present invention, when a basic picture drawn on each of the basic cards is that of a girl and pictures of other cards to be superimposed on the basic card are those of clothes and accessories, the card toy that enables dress-up play to be enjoyed by use of the cards can be provided.

According to one embodiment of the present invention, although a single card can not give a message to another person, the card toy in which not only are the pictures drawn on the cards combined to compose a composite picture but also information transfer that can transfer a message to another person with the use of the cards becomes possible by superimposing a plurality of the cards on one another can be provided.

### BRIEF DESCRIPTION OF THE DRAWINGS

FIGS. 1(a) to 1(f) are views illustrating cards that make up a card toy of the present invention, wherein the cards are divided into groups;

FIGS. 2(a) to 2(f) are views each illustrating a state in which one card is selected from each group;

FIGS. 3(a) to 3(e) are views each illustrating a state in which the selected cards are sequentially superimposed; and

FIG. 4 is a view illustrating a visible picture in a state of all the selected cards being superimposed.

### BEST MODE FOR CARRYING OUT THE INVENTION

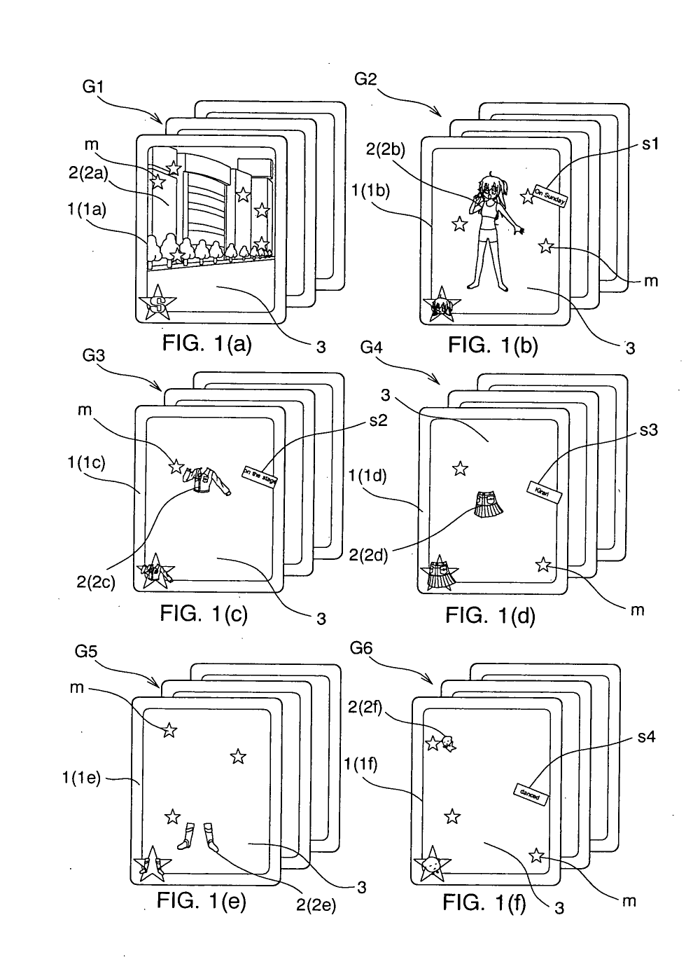

FIGS. 1(a) to 1(f) represent an embodiment of a card toy according to the present invention. The card toy of this embodiment comprises cards 1 that are divided into a plurality of groups and enables playing therewith by selecting one card 1 from each group and superimposing the selected cards 1 on one another.

In this embodiment, the card toy enables a user to enjoy dress-up play in which a girl depicted on a basic card as a picture 2 puts on her clothes by superimposing, on the basic card, the dress-up element cards on which clothes and footwear such as shoes, skirts, and tops are depicted as pictures. The card toy is constituted by the cards 1 (1a to 1f) that are divided into six groups consisting of: a stage group G1 of which cards have backgrounds depicted thereon as pictures (refer to FIG. 1(a)); a character group G2 made-up by the basic cards which have characters depicted thereon as basic pictures (refer to FIG. 1(b)); a tops group G3 of which cards have tops such as shirts, etc. drawn thereon as pictures (refer to FIG. 1(c)); a bottoms group G4 of which cards have bottoms such as skirts, etc. depicted as pictures (refer to FIG. 1(d)); a footwear group G5 of which cards have footwear drawn thereon as pictures (refer to FIG. 1(e)); and an accessory group G6 of which cards have fancy goods such as accessories, etc. drawn thereon as pictures (refer to FIG. 1(f)).

The cards 1 described above are each a sheet made of a transparent material having the respective picture 2 printed on the surface thereof. When the cards 1 are superimposed on one another, in the case where the picture 2 of the card 1 located at an upper position overlaps the picture 2 of the card 1 located at a lower position, an overlapped portion of the picture 2 of the card located at the lower position is concealed by the picture 2 of the card located at the upper position; and in the case where the picture 2 of the card located at the lower position and the picture 2 of the card located at the upper position do not overlap each other, a portion of the picture 2 of the card located at the lower position which portion corresponds to a portion of the picture 2 of the card located at the upper position which has no picture therein is visible through a transparent portion 3 of the card located at the upper position, whereby a picture composed by the pictures 2 of the card located at the lower positions and the pictures 2 of the cards at the upper positions can be seen.

It should be noted that the cards 1a of the stage group G1 are not necessarily made of a transparent material and instead the cards 1a may be made of an opaque material because each of the cards 1a is always placed at the lowermost position.

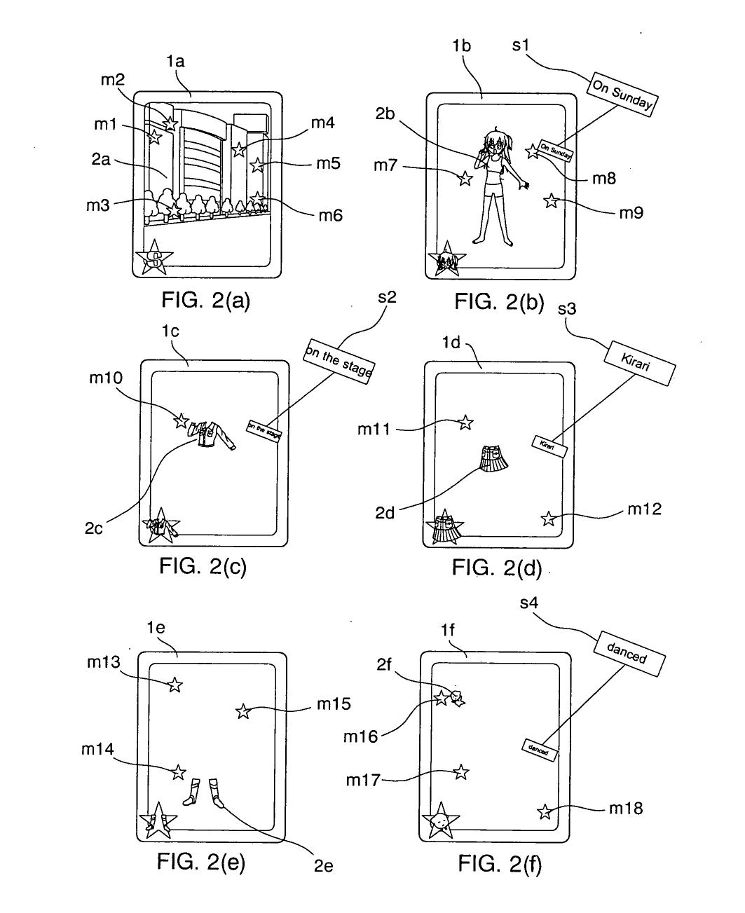

When the card toy constructed as described above is used for card play, first, one each of the cards 1a to 1f is selected from the six groups G1 to G6 as shown in FIGS. 2(a) to 2(f).

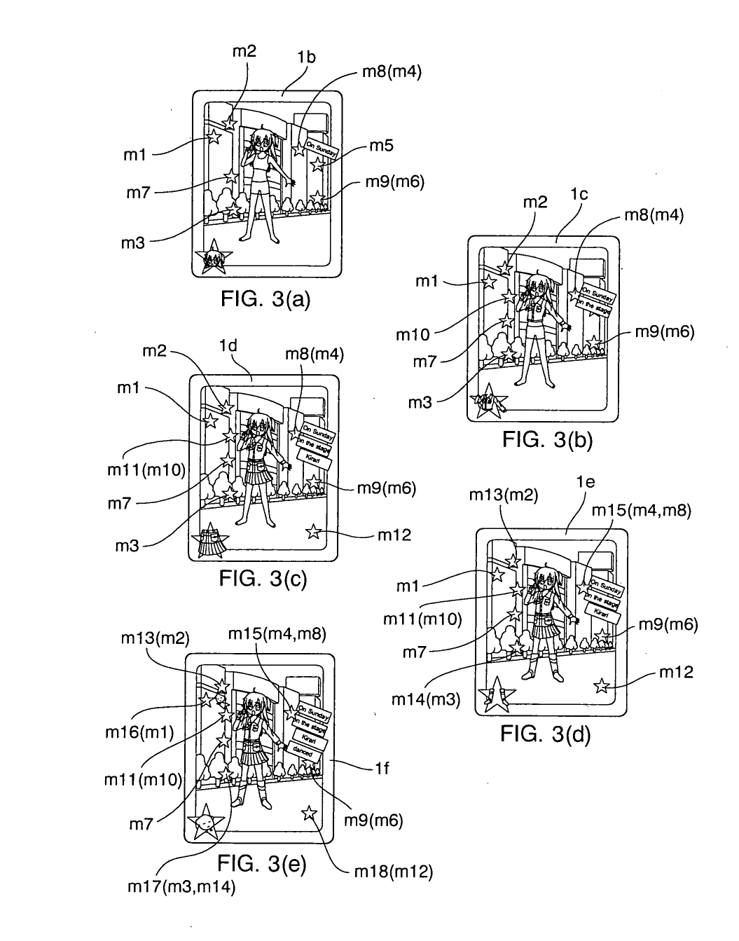

Next, when the basic card 1b is superimposed on the card 1a, a picture 2b of a character that is a basic picture overlaps a picture 2a of a background. As shown in FIG. 3(a), the picture 2b of the card 1b located at the upper position is seen in an area where a part of the picture 1a is covered by a part of the picture 2b, and a part of the picture 2a of the card 1a located at the lower position can be seen in an area where the part of the picture 2a is not covered by any part of the picture 2b, resulting in that a girl standing in a town can be seen.

Further, when a card 1c having a shirt 2c depicted thereon as a picture 2 is superimposed on the card 1b, parts of the pictures 2a and 2b below the card 1c are seen as they are without any change in an area where the parts of the pictures 2a and 2b a are not covered by any part of the picture 2c, and the picture 2c is only seen in an area where parts of the pictures 2a and 2b are covered by the picture 2c, resulting in a state in which the girl is wearing the shirt can be seen (refer to FIG. 3(b)).

Next, when a card 1d having a skirt 2d printed thereon as a picture 2 is superimposed on the card 1c, parts of the pictures 2a, 2b and 2c below the card 1d are seen as they are without any change in an area where the parts of the pictures 2a, 2b and 2c are not covered by the picture 2d, and the picture 2d is only seen in an area where parts of the pictures 2a, 2b and 2c are covered by the picture 2d, resulting in a state in which the girl is wearing the skirt can be seen (refer to FIG. 3(c)).

Further, when a card 1e having a pair of boots 2e printed thereon as a picture 2 is superimposed on the card 1d, parts of the pictures 2a to 2d below the card 1e are seen as they are without any change in an area where the parts of the pictures 2a to 2d are not covered by the picture 2e, and the picture 2e is only seen in an area where parts of the pictures 2a to 2d are covered by the picture 2e, resulting in a state in which the girl is wearing the boots can be seen (refer to FIG. 3(d)).

Finally, when a card 1f having an accessory 2f printed thereon as a picture 2 is superimposed on the card 1e, parts of the pictures 2a to 2e below the card 1f are seen as they are without any change in an area where the parts of the pictures 2a to 2e are not covered by the picture 2f, and only the picture 2f is seen in an area where parts of the pictures 2a to 2e are covered by the picture 2f and concealed thereby, resulting in a state in which the girl is wearing the accessory that is her favorite one can be seen (refer to FIG. 3(e)).

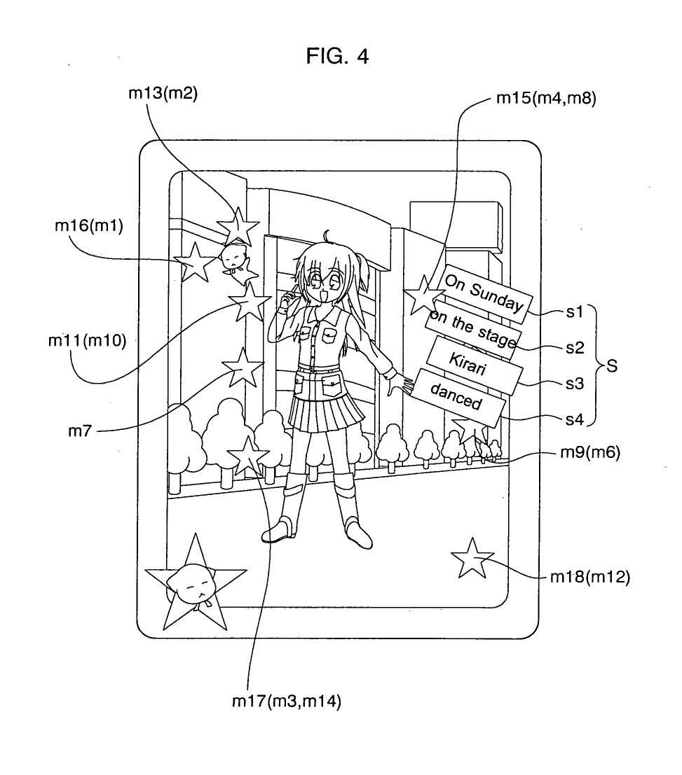

As described above, by superimposing the cards 1 on one another, a picture of the girl who wears the clothes and boots and is standing in a town can be composed or represented as shown in FIG. 4.

On the cards 1, predetermined marks m (for example, star-shaped marks) are drawn in addition to the pictures 2 described above. The marks m appear to be arranged at random; however, the arrangement of the marks m are practically designed such that some of the marks m drawn on certain cards 1 may match the mark or marks m drawn on the other cards 1 but some of the marks m do not overlap with each other depending on a combination of the cards when the cards 1 are superimposed.

For example, the card 1a has marks m1 to m6 printed thereon and the card 1b has marks m7 to m9 printed thereon, and therefore the number of the marks m of the two cards is nine in total. However, when the card 1b is superimposed on the card 1a, the mark m4 and the mark m8 match each other and the mark m6 and the mark m9 match each other. Hence, actually visible marks are m1, m2, m3, m5, m7, m8, and m9, and the number of the marks m is seven. The number of marks m of the cards 1a to 1f is 18, i.e. m1 to m18. However, when the cards 1a to 1f are superimposed on one another, only eight marks m, namely, marks m7, m9, m11, m13, m15, m16, m17, and m18 can be eventually seen as shown in FIG. 4. Since the final number of the marks m in total cannot be determined until all the cards are superimposed, the number of the marks can be used for a game similar to, for example, a game using playing cards in which cards having a higher number of diamonds, spades or the like are competed for.

In order not to figure out which marks are actually matched each other or which marks do not overlap with each other before the cards are superimposed, a rule for the game may be made such that once a card is selected for superimposing, the card cannot be exchanged.

Further, some cards have printed thereon words and/or phrases (for example, when, where, who, and what is done) divided from one sentence, and the complete sentence is formed by superimposing the cards. When a sentence S, for example, “Kirari danced on the stage on Sunday.” is divided into four words/phrases s1 to s4 of “on Sunday”, “on the stage”, “Kirari”, and “danced” and each of the words/phrases is printed on a separate card, a complete sentence is formed by superimposing the cards on one another. Therefore, a card toy can be realized which can provide not only play by simply composing a picture but also an information transfer function for giving some kind of message to another person.

It should be noted that the area for printing the above word/phrase may be printed in white ink so as to permit a user to write a short sentence by hand in the area.

DESCRIPTION OF REFERENCE NUMERALS AND SYMBOLS

| | |
|---|---|
| 1, 1a, 1b, 1c, 1d, 1f | Card |
| 2, 2a, 2b, 2c, 2d, 2e, 2f | Picture |
| 3 | Transparent portion |
| G1, G2, G3, G4, G5, G6 | Group of cards |
| m, m1 to m18 | Mark |
| S | Sentence |
| s1, s2, s3, s4 | Word or phrase |

1. A card toy used for playing by superimposing a plurality of cards made of a transparent material on a card made of a transparent or opaque material, characterized in that:
the card toy comprises cards that have respective pictures indicated thereon, wherein the pictures are so arranged that when one of the cards is superimposed on another card, the picture of the card located at an upper position conceals at least part of the picture of the card located at a lower position and is combined with the picture of the card located at the lower position;
the cards include a plurality of groups each of which consists of a plurality of cards, wherein when cards of which one is selected from each group are superimposed on one another, a predetermined design is made; and
the cards have a plurality of marks of a predetermined shape indicated thereon in addition to the picture, respectively, in such a manner that at least one of the marks of one card may be covered by a corresponding one of the marks on the other cards depending on a combination of the selected cards.

2. The card toy according to claim 1, wherein one of the groups consists of basic cards on which the pictures are respectively depicted as a basic picture, and the cards of the other groups that are superimposed on the basic card have the respective pictures depicted thereon so as to decorate the basic picture.

3. The card toy according to claim 1, wherein the cards have respective words and/or phrases indicated thereon in letters in addition to the pictures and the marks, and when the selected cards are superimposed, the word and/or phrase of each card is/are connected to the words and/or phrases of other cards, to thereby make up one sentence.

4. The card toy according to claim 2, wherein the cards have respective words and/or phrases indicated thereon in letters in addition to the pictures and the marks, and when the selected cards are superimposed, the word and/or phrase of each card is/are connected to the words and/or phrases of other cards, to thereby make up one sentence.
